(19) United States
(12) Patent Application Publication
(10) Pub. No.: US 2016/0110356 A1
(43) Pub. Date: Apr. 21, 2016

(54) HASH TABLE CONSTRUCTION FOR UTILIZATION IN RECOGNITION OF TARGET OBJECT IN IMAGE

(71) Applicant: Empire Technology Development LLC, Wilmington, DE (US)

(72) Inventor: Ezekiel Kruglick, Poway, CA (US)

(21) Appl. No.: 14/649,894

(22) PCT Filed: Mar. 31, 2014
(86) PCT No.: PCT/US14/32385

§ 371 Date: Jun. 4, 2015

(51) Int. Cl. G06F 17/30; G06T 11/00; G06T 15/00; G06K 9/46

(52) U.S. Cl. CPC G06F 17/3033; G06K 9/46; G06T 11/00; G06T 15/005; G06F 17/3028

(57) ABSTRACT

Technologies are generally described to construct a hash table for utilization in a recognition of a target object in an image. According to some examples, a system to serve topical image recognition hash tables to user devices may construct a lookup hash table union from disjoint hash tables of particular objects. For example, a server may receive a request for a category or list of items, interpret which objects to send, and compose a joined image hash lookup table from the disjoint objects that match the target set. In other examples, the category information may be expanded into an object list and hash collections associated with the object list may be retrieved.

### BACKGROUND

Unless otherwise indicated herein, the materials described in this section are not prior art to the claims in this application and are not admitted to be prior art by inclusion in this section.

Object recognition within an image is a computation intensive task. Conventional object recognition approaches typically scan the image one pixel at a time through one or more filters to recognize patterns in a collection of pixels. Thus, the conventional object recognition approaches may necessitate relatively large computation resources including extensive processing, memory, and storage resources. Hence, modern mobile devices may not provide object recognition beyond limited applications because of limited computing resources. Server side processing may also be an insufficient solution to provide object recognition functionality in mobile devices. Network bandwidth limitations and other issues may prevent mobile devices from implementing a sufficient object recognition solution.

### SUMMARY

The present disclosure generally describes methods, apparatus, systems, devices, and/or computer program products related to construction of a hash table for utilization in recognition of a target object in an image.

According to some examples, methods are provided to construct a hash table for utilization in recognition of a target object in an image. An example method may include receiving a category information of the target object, expanding the category information into an object list, retrieving hash collections associated with the object list, and joining the hash collections into the hash table.

According to other examples, a hash table server configured to construct a hash table for utilization in recognition of a target object in an image is described. The hash table server may include a memory configured to store instructions coupled to a processor. The processor may be configured to receive a category information of the target object that includes an identity of an entity arranged for the recognition, where the entity is optionally associated with the image, expand the category information into an object list, retrieve hash collections associated with the object list from a hash data store configured to manage object hash tables that store object patterns, and join the hash collections into the hash table.

According to further examples, a system is described. The system may include a client device configured to capture an image, and a hash table server configured to construct a hash table for utilization in recognition of a target object in the captured image. The hash table server may include a memory configured to store instructions and a processor coupled to the memory. The processor may be configured to receive a category information of the target object that includes an identity of an entity provided for the recognition, where the entity is optionally associated with the image that is a two dimensional graphic or a three dimensional graphic, expand the category information into an object list, retrieve hash collections associated with the object list from a hash data store configured to manage object hash tables that store object patterns, and join the hash collections into a hash table.

According to other examples, a computer-readable non-transitory storage medium with instructions stored thereon to construct a hash table for utilization in recognition of a target object in an image. The instructions may cause a method to be performed in response to execution, the method being similar to the method described above.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates a high level diagram of an example system configured to construct a hash table for utilization in recognition of a target object in an image;

FIG. 2 illustrates a component diagram of example schemes to recognize objects in an image;

FIG. 3 illustrates a component diagram of an example system configured to construct a hash table for utilization in recognition of a target object in an image;

FIG. 4 illustrates a general purpose computing device, which may be used to construct a hash table for utilization in recognition of a target object in an image;

FIG. 5 is a flow diagram illustrating an example method to construct a hash table for utilization in recognition of a target object in an image; and

FIG. 6 illustrates a block diagram of an example computer program product to construct a hash table for utilization in recognition of a target object in an image,

all arranged in accordance with at least some embodiments described herein.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to construction of a hash table for utilization in recognition of a target object in an image.

Briefly stated, technologies are generally described to construct a hash table for utilization in a recognition of a target object in an image. According to some examples, a system to serve topical image recognition hash tables to user devices may construct a lookup hash table union from disjoint hash tables of particular objects. For example, a server may receive a request for a category or list of items, interpret which objects to send, and compose a joined image hash lookup table from the disjoint objects that match the target set. In other examples, the category information may be expanded into an object list and hash collections associated with the object list may be retrieved.

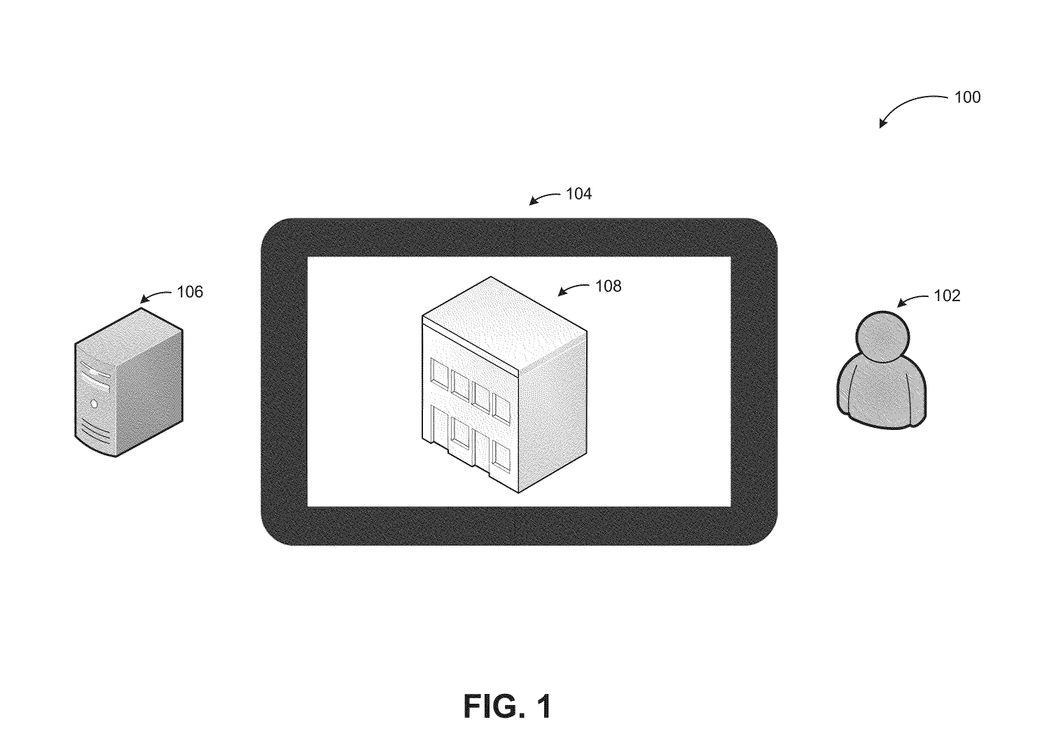

FIG. 1 illustrates a high level diagram of an example system configured to construct a hash table for utilization in recognition of a target object in an image, arranged in accordance with at least some embodiments described herein.

As shown in a diagram 100, a device 104 may display content such as an image or a video to a user 102. The content may be retrieved from a local storage, a local content provider, an external content provider, and similar sources. Alternatively, the content may be captured by the device 104. An example may include the user 102 who captures an image through a camera module of the device 104. The device 104 may display the captured image as content to the user 102.

The user 102 may request for objects in the displayed image to be recognized by the device 104. Object recognition within an image may be a hardware resource intensive activity. The device 104 may not have the hardware resources to provide object recognition within an image at an average speed as defined by a common use case associated with the user 102. As such, the device 104 may delegate object recognition tasks in part or in whole to an external resource such as a server 106.

In an example scenario, the user 102 may provide a category information associated with a target object 108 within an image displayed by the device 104. The target object 108 may include an identification of an entity. The entity may be represented by the target object 108. The entity may also be optionally associated with the image. In an example scenario, the user 102 may identify the entity as the target object 108 that is displayed within the image by the device 104. Alternatively, the target object 108 may be the identification of an entity that is not related to an image. An example scenario may include the user 102 providing the identification of an entity to the device 104 in preparation of recognition of one or more objects associated with the entity.

In addition, the category information may be a classification of the target object 108 such as an identifier that associates the target object 108 with an abstract group. Examples of category information may include vehicles, trees, buildings, people, animals, and similar ones. Category information may be provided by the user or may be based on context such as location, an active application, or a preliminary evaluation of the image. The user 102 may identify the category information as a building for the target object 108. The device 104 may transmit the category information as identified by the user 102 for the target object 108 to the server 106 to initiate object recognition for the image displayed by the device 104.

The server 106 may receive the category information for the target object 108. The server 106 may execute an expansion operation to transform the category information into an object list. The object list may include a list of terms, such as the category information, that describe the target object 108. The expansion operation may include a determination of one or more synonym terms associated with the category information. The category information and the synonym terms may be combined in the object list. In an example scenario, the user 102 or context may identify the target object 108 as a building. The building may be identified as the category information. The server 106 may execute the expansion operation to determine synonym terms for the building. The server 106 may search term groupings stored in a local or an external a language data store such as a dictionary to find the synonym terms. The server 106 may find synonym terms such as an office complex, an apartment building, a dwelling, a house, a skyscraper, and similar ones. The synonyms terms may be combined with the category information into the object list. Expansion of terms may also be limited or expanded by context data such as a location that provides for specific buildings or other structures to be identified for the object list.

In addition, hash collections associated with the object list may be retrieved from a hash data store. The hash data store may be a local data store of the server 106 or an external data store. The server 106 may join the hash collections into a hash table. The hash table may be sent to the device 104 to allow the device 104 to do local object recognition of the displayed image. The target object 108 may be recognized using the hash table.

Furthermore, the hash table may be generated prior to an initiation event associated with an image. The server 106 may generate one or more hash collections associated with one or more objects. The server 106 may match and reduce to identity features that use computation across a corpus of images to generate the hash collections. The hash collections may be joined to hash tables. The hash tables may be packaged with one or more applications to integrate recognition functionality with the applications. An example may include an addition of a package of hash tables that allow an imaging application to recognize a category of objects such as vehicles. An example category may include sedans. The hash tables may also be provided to external applications as add on packages such as plug-ins and similar ones.

The above-discussed examples are not provided in a limiting sense. Other schemes may be used to construct a hash table for utilization in recognition of a target object in an image.

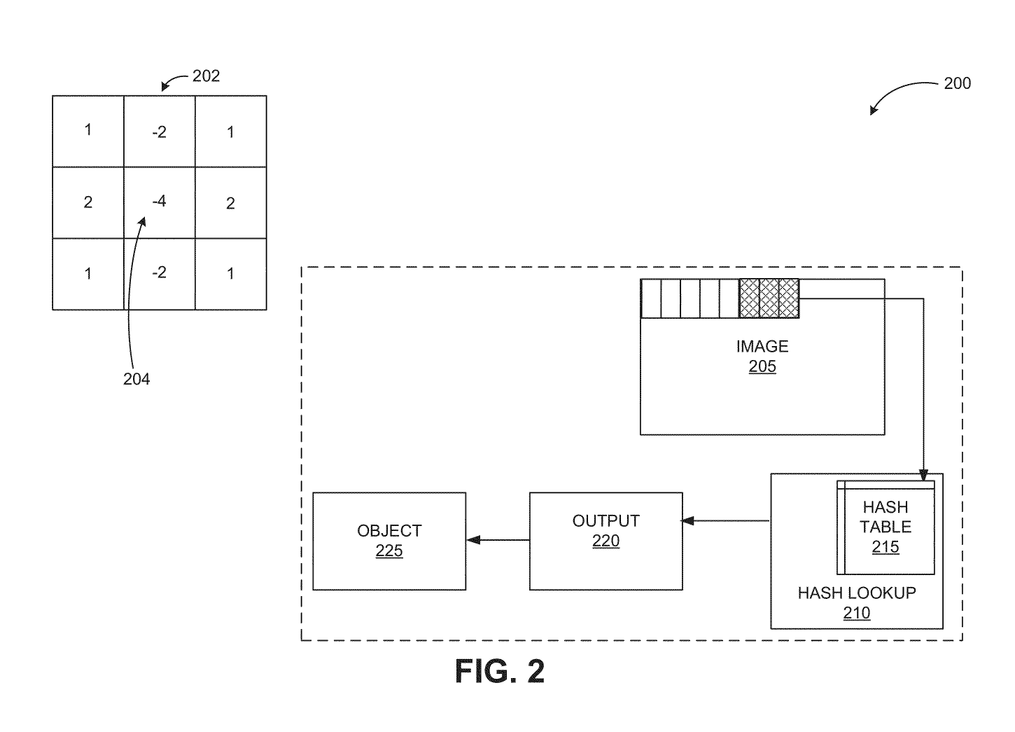

FIG. 2 illustrates a component diagram of example schemes to recognize objects in an image, arranged in accordance with at least some embodiments described herein.

As shown in a diagram 200, a kernel 202 may be a component of a conventional scheme to recognize an image 205 in a task. The kernel 202 may be a fixed size array of numerical coefficients with an anchor point 204 in the array. The anchor point 204 may typically be located at a center of the kernel 202. The kernel 202 may be convolved across X/Y pixels of the image 205 to generate a value for each pixel that represent a sum of the coefficients when the anchor point 204 is at that pixel. In an example scenario, when applying a convolution to an example pixel (100,100) of the image 205, the kernel 202 may be a sum of [1×Value(99,99)]+[−2×Value(100,99)]+[1×Value(101,99)]+[2×Value(99,100)]+[−4×Value(100,100)]. The convolution may be expressed as an equation:

$$H ( x , y ) = {\sum }_{i = 0}^{{M}_{i} - 1} {\sum }_{j = 0}^{{M}_{j} - 1} I ( x + i - {a}_{i} , y + j - {a}_{j} ) K ( i , j )$$

which may be applied to each pixel of the image 205. A variable H(x, y) may be determined to be an output of the kernel 202 when the anchor point 204 may be at a location x, y. The kernel 202 may have a size of a variable i by a variable j with values K(i, j) at each point within the kernel 202. The variables i and j may be iterated by a summation across the kernel 202. The variables of a sub i and j may include a location of the anchor point 204 in the kernel 202. A value of I(n, m) may be an image value at a pixel (n, m). In an example scenario, in response to a use of values 0, 0 as the anchor point 204 in the kernel 202, the values of variables i and j may vary from a value of −1 to 1 and the value of a variable a which may be 0. In addition, the values of variables I and K may iterate from I(−1, −1) and K(−1, −1) to I(1, 1) and K (1, 1). Furthermore, the kernel 202 may be used in an image filter that may be used to recognize an object 225 in the image 205. Typical filters may use multiple kernels for object recognition. One or more filters may be used for object recognition in the image 205.

In a new object recognition scheme, each part of the image 205 may be hashed compared to use of the kernel 202 to convolve each pixel of the image 205 in a traditional object recognition scheme. The hashes may be used to consult a hash table 215 for use in a hash table lookup 210 operation. The hash table lookup 210 may generate an output 220 that may include a dictionary of objects which may include the object 225.

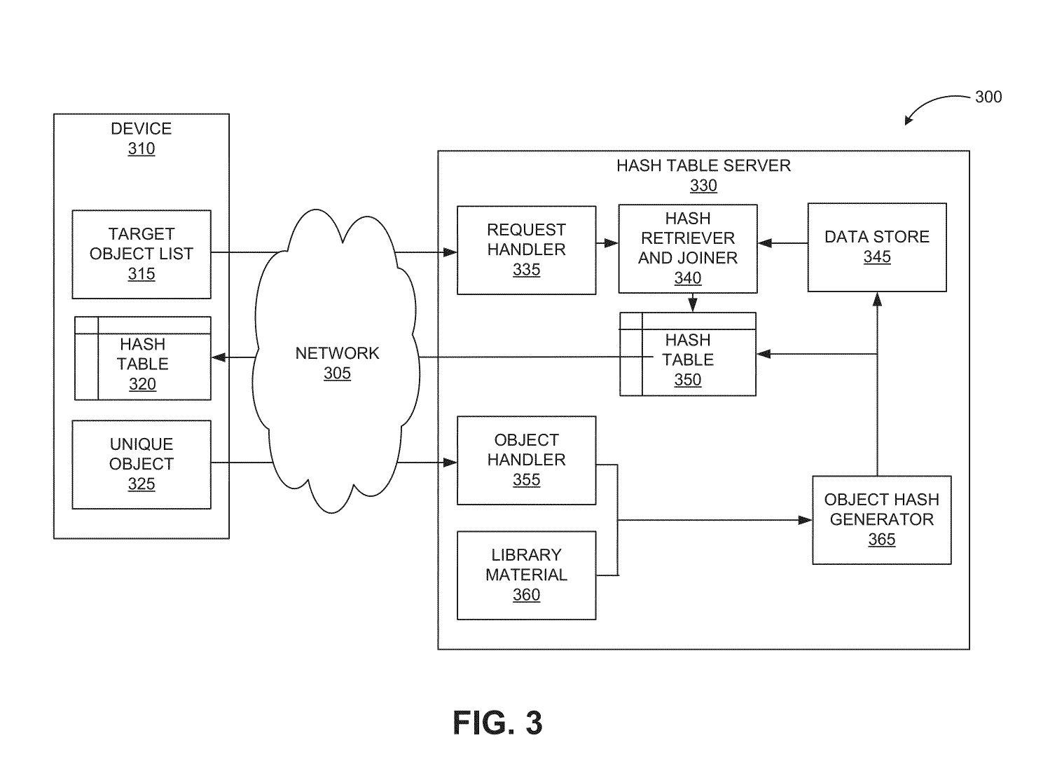

FIG. 3 illustrates a component diagram of an example system configured to construct a hash table for utilization in recognition of a target object in an image, arranged in accordance with at least some embodiments described herein.

As shown in a diagram 300, a hash table server 330 may receive a target object list 315 transmitted from a device 310 through a network 305. Alternatively, a target category transmitted from the device 310 through the network 305 may be received by the hash table server 330. The target category may be an enumeration of category information associated with the target object. The category information may be a classification of the target object such as an identifier that associates the target object with an abstract group The target object list 315 may be generated based on a user input received on the device 310. A request handler 335 may receive the target object list 315.

The request handler 335 may execute an expansion operation to expand the target object list 315. An example of the expansion operation may include a search for one or more synonym terms associated with the terms that identify the target object within the target object list 315. The synonym terms may be added to the target object list 315. In addition, the request handler 335 may formalize the target object list 315 by following a set of rules. For example the rules may identify a number of items not within the same category but which are often confused with one or more target objects and include those items on the object list in order to enhance discrimination between the two. Other formalizations may include other rules such as the inclusion of pre-established lists such as animals of a certain area, objects associated with a particular context or trade, or objects associated with an application or location.

Objects known to conflict with target objects from the target objects list 315 may be added to the target object list 315 to eliminate false positives. The conflicting objects may be retrieved from a data store 345. False positives may be eliminated by generating correct identifications for the conflicting objects. The resulting object list may be transmitted to a hash retriever and joiner module 340.

The hash retriever and joiner module 340 may retrieve object hash collections related to the objects within the resulting object list from the data store 345. The data store 345 may store the hashes of the hash collections separately or in groups based on an object associated with each hash collection. The hash retriever and joiner module 340 may join the hash collections into a hash table 350. The hash table 350 may have a single key value for each stored hash and any number of output values. A key-value set may be a tuple or a dictionary of a related object and a metric produced for a hash of the related object. A metric may be any measurement of an attribute of the related object used to recognize the related object.

The hash table 350 may be transmitted to the device 310 through the network 305. The device 310 may store the hash table 350 locally as a hash table 320. The hash table 320 may be used to recognize a target object in an image based on the category information provided by a user or other entity requesting the object to be recognized in the image. The previous operations associated with the target object list 315 may also be implemented with a target category as an alternative to the target object list 315. The target category may be an enumeration of category information associated with the target object.

According to some embodiments, an object handler 355 may receive an image or other data from the device 310 in response to a transmission from the device 310 through the network 305. The transmission may cause the hash table server 330 to recognize an object 325. The object handler 355 may provide a library material 360 to an object hash generator 365. The library material 360 may be a subset of the hashes stored the data store 345 that may be aggregated to guide the object hash generator 365. The object hash generator 365 may generate object hashes from the object 325 and the library material 360. The library material 360 may include training material to guide the object hash generator 365 during generation of the object hashes, such as by providing similar objects to guide the object hash generator 365 in choosing or weighting distinct features of recognition. The hashes may be added to the hash table 350. The hashes may also be stored in the data store 345 for future retrieval to generate a new hash table.

The data store 345 may grow to vast numbers of objects with a high number of discriminatory abilities in response to generation and storage of object hashes from the object 325. Privacy settings may be set to control hashes for personal objects stored in the data store 345 which may cause false positives during a recognition of the object 325. Quality control algorithms may be employed to eliminate the false positives.

Hash based image recognition—unlike two dimensional (2D) kernels based image recognition—may not be restricted to two dimensions. Hash based image recognition may be applied to three dimensional (3D)) data through a depth map camera or synthesized from multiple images of an object. A parallel scheme may be implemented to serve hash tables based on volumetric hashes.

The target object list 315 or category may also include contextual data to help the hash table server 330 choose which hashes to provide. In an example scenario, the device 310 may request hashes to recognize a category of objects such as animals. The hash table server 330 may determine the location where the image was captured through location metadata embedded in the image. Alternatively, the location information may be provided to the hash table server 330 by the device 310 during a transmission of the target object list 315. In an example scenario, in response to a determination that the location of the device 310 is within a special region such as a wild life area, the request handler 335 may reduce the target object list 315 to a subset of the objects such as wild animals. The target object list 315 may be reduced to a subset to allow the device 310 to warn a user about the subset recognized in the image. Alternatively, in response to detection of context such as a location, the target object list 315 may be expanded to include a category associated with the object such as animals. In an example scenario, an entity such as a monkey may be recognized. In response to a detection that a location associated with the object is a zoo, the object list may be expanded to zoo type animals at the location. A hash table that includes hashes of objects associated with the context may be constructed and transmitted to the device 310.

Hash based image recognition may provide hash table construction using extensive object libraries at increased speed through computation resources available to the hash table server 330. In comparison, the device 310 may lack computation resources to provide hash table construction. Computation of the hash table 350 at the hash table server 330 may also reduce power consumption at the device 310 for object recognition tasks. In addition, hash generation at the hash table server 330 may reduce compute resources that may be needed to recognize a new object in an image at the device 310. In an example scenario, when the device 310 provides a target category such as buildings, the hash table server 330 may generate the hash table 350 for building objects such as 1,000 buildings at 200 KB per object. A result may be the hash table 320, that is stored locally, that may be 200 MB in size, which may not tax computing resources of the device 310 during a recognition of a building object in an image.

In an example scenario, an application may be allowed to request one or more hash tables for one or more target categories of one or more objects. For example, the application may offer functions such as recognition of objects for automated sales, value estimation, recycling information associated with the objects, user guidance to shop for similar or complementary objects, and similar ones. A request may be received from the application for a hash table. Additionally the application may be allowed to subscribe to a target category associated with the hash table. Update packages may be sent to the application to provide changes to the hash table that may be stored locally to allow the application to improve recognition functionality.

The examples in FIGS. 1 through 3 have been described using specific systems and processes in which construction of a hash table for utilization in recognition of a target object in an image may be implemented. Embodiments for construction of a hash table for utilization in recognition of a target object in an image are not limited to the systems and processes according to these examples. It should also be recognized that requesting and construction of a hash table may occur at any time including significantly in advance of any recognition task (e.g. when a recognition app is configured) or may happen in response to an immediate recognition task.

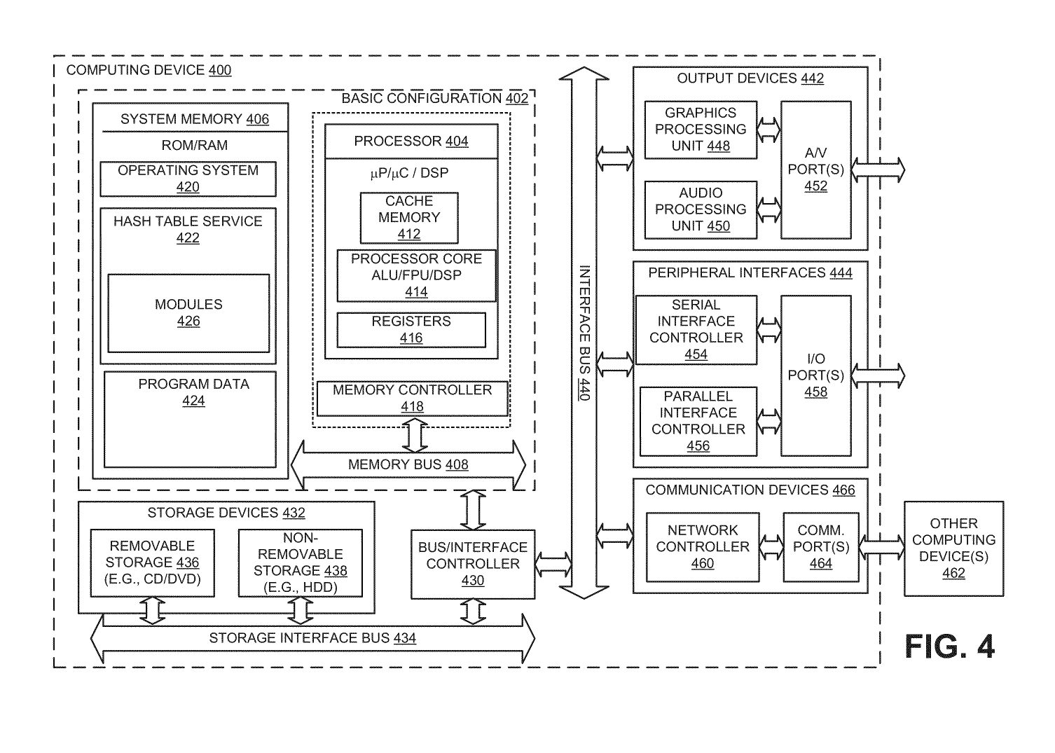

FIG. 4 illustrates a general purpose computing device, which may be used to construct a hash table for utilization in recognition of a target object in an image, arranged in accordance with at least some embodiments disclosed herein.

For example, a computing device 400 may be used to provide computer program products related to a hash table construction for utilization in recognition of a target object in an image. In an example basic configuration 402, the computing device 400 may include one or more processors 404 and a system memory 406. A memory bus 408 may be used for communicating between the processor 404 and the system memory 406. The basic configuration 402 is illustrated in FIG. 4 by those components within the inner dashed line.

Depending on the desired configuration, the processor 404 may be of any type, including but not limited to a microprocessor (μP), a microcontroller (μC), a digital signal processor (DSP), or any combination thereof. The processor 404 may include one more levels of caching, such as a level cache memory 412, a processor core 414, and registers 416. The example processor core 414 may include an arithmetic logic unit (ALU), a floating point unit (FPU), a digital signal processing core (DSP Core), or any combination thereof. An example memory controller 418 may also be used with the processor 404, or in some implementations, the memory controller 418 may be an internal part of the processor 404.

Depending on the desired configuration, the system memory 406 may be of any type including but not limited to volatile memory (such as RAM), non-volatile memory (such as ROM, flash memory, etc.), or any combination thereof. The system memory 406 may include an operating system 420, a hash table service 422, and a program data 424. The hash table service 422 may include modules 426, including the request handler 335, the object handler 355, the hash retriever and joiner module 340, and the object hash generator 365. The program data 424 may include, among other data, the hash table 350 associated with one or more hash collections stored by the data store 345, or the like, as described herein.

The computing device 400 may have additional features or functionality, and additional interfaces to facilitate communications between the basic configuration 402 and any desired devices and interfaces. For example, a bus/interface controller 430 may be used to facilitate communications between the basic configuration 402 and one or more data storage devices 432 via a storage interface bus 434. The data storage devices 432 may be one or more removable storage devices 436, one or more non-removable storage devices 438, or a combination thereof. Examples of the removable storage and the non-removable storage devices may include magnetic disk devices, such as flexible disk drives and hard-disk drives (HDD), optical disk drives such as compact disc (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 406, the removable storage devices 436, and the non-removable storage devices 438 may be examples of computer storage media. Computer storage media may include, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (for example, one or more output devices 442, one or more peripheral interfaces 444, and one or more communication devices 466) to the basic configuration 402 via the bus/interface controller 430. Some of the example output devices 442 may include a graphics processing unit 448 and an audio processing unit 450, which may be configured to communicate to various external devices, such as a display or speakers via one or more A/V ports 452. One or more example peripheral interfaces 444 may include a serial interface controller 454 or a parallel interface controller 456, which may be configured to communicate with external devices, such as input devices (for example, keyboard, mouse, pen, voice input device, touch input device, etc.) or other peripheral devices (for example, printer, scanner, etc.) via one or more I/O ports 458. An example communication device 466 may include a network controller 460, which may be arranged to facilitate communications with one or more other computing devices 462 over a network communication link via one or more communication ports 464. The one or more other computing devices 462 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 400 may be implemented as a part of a general purpose or specialized server, mainframe, or similar computer, which includes any of the above functions. The computing device 400 may also be implemented as a personal computer including both laptop computer and non-laptop computer configurations.

Example embodiments may also include methods for construction of a hash table for utilization in recognition of a target object in an image. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

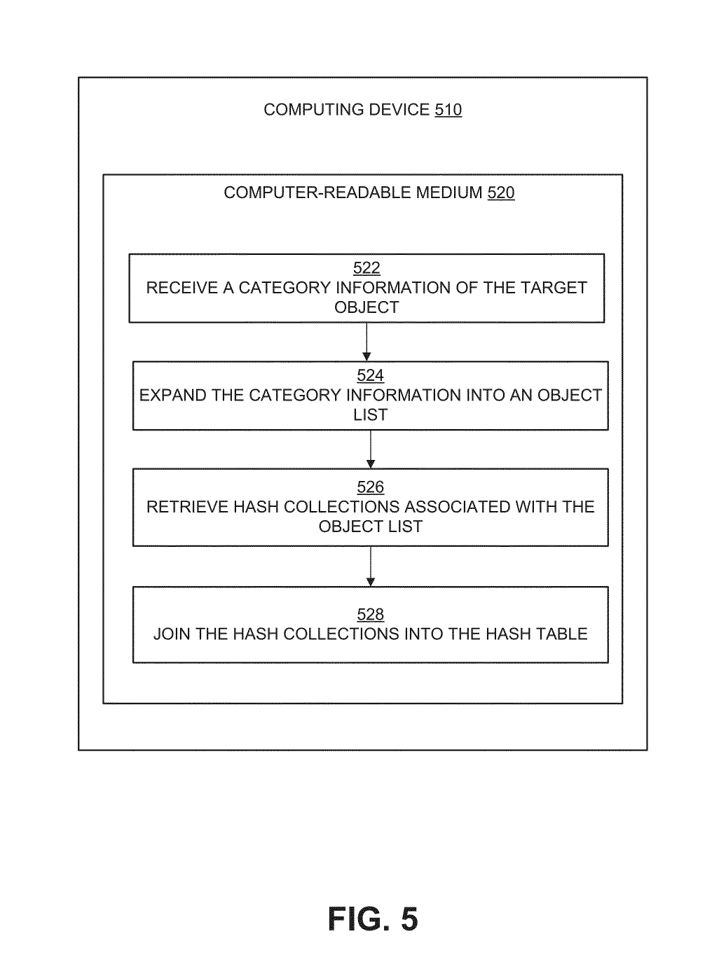

FIG. 5 is a flow diagram illustrating an example method to construct a hash table for utilization in recognition of a target object in an image that may be performed by the hash table server 330 which is an example of the computing device 400, arranged in accordance with at least some embodiments disclosed herein.

Example methods may include one or more operations, functions, or actions as illustrated by one or more of blocks 522, 524, 526, and 528, and may, in some embodiments, be performed by a computing device such as the computing device 400 in FIG. 4. The operations described in the blocks 522-528 may also be stored as computer-executable instructions in a computer-readable medium such as a computer-readable medium 520 of a computing device 510.

An example process for construction of a hash table for utilization in recognition of a target object in an image may begin with block 522, “RECEIVE A CATEGORY INFORMATION OF THE TARGET OBJECT,” where the request handler 335 may receive the category information.

Block 522 may be followed by block 524, “EXPAND THE CATEGORY INFORMATION INTO AN OBJECT LIST,” where the request handler 335 may search for similar or equivalent object information to add to the object list.

Block 524 may be followed by block 526, “RETRIEVE HASH COLLECTIONS ASSOCIATED WITH THE OBJECT LIST,” where the hash retriever and joiner module 340 may retrieve hash collections associated with the object list from the data store 345.

Block 526 may be followed by block 528, “JOIN THE HASH COLLECTIONS INTO THE HASH TABLE,” where the hash retriever and joiner module 340 may join the hash collection into the hash table that may be transmitted to a client device to allow the client device to recognize an object in an image with the hash table.

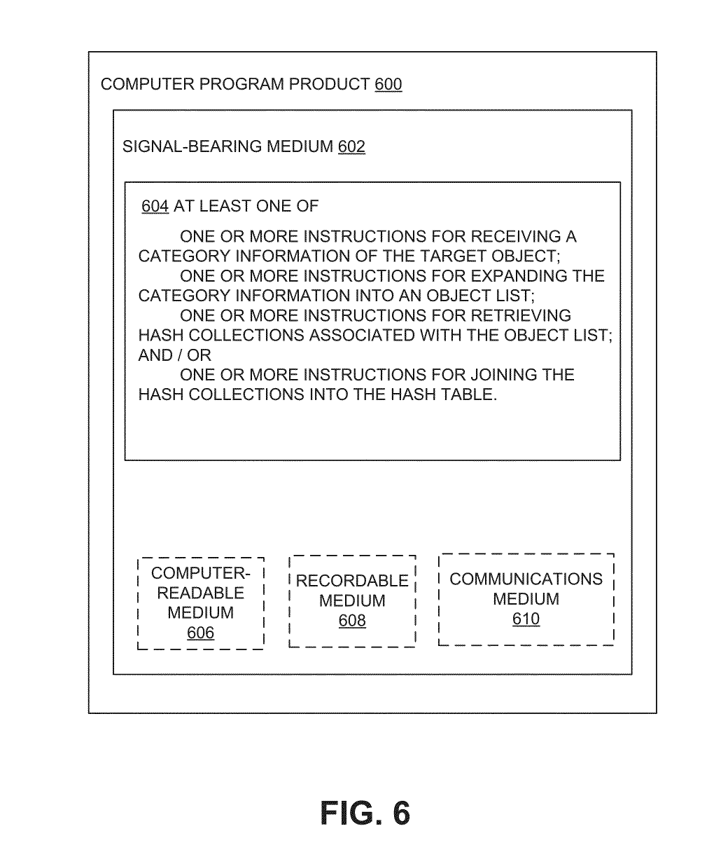

FIG. 6 illustrates a block diagram of an example computer program product to construct a hash table for utilization in recognition of a target object in an image, arranged in accordance with at least some embodiments described herein.

In some examples, as shown in FIG. 6, a computer program product 600 may include a signal bearing medium 602 that may also include one or more machine readable instructions 604 that, when executed by, for example, a processor, may provide the functionality described herein. For example, referring to the processor 404 in FIG. 4, the hash table service 422 and the modules 426 may undertake one or more tasks shown in FIG. 6 in response to the instructions 604 conveyed to the processor 404 by the medium 602 to construct a hash table for utilization in recognition of a target object in an image, as described herein. Some of those instructions may include, for example, receiving a category information of the target object, expanding the category information into an object list, retrieving hash collections associated with the object list, and joining the hash collections into the hash table.

In some implementations, the signal bearing medium 602 depicted in FIG. 6 may encompass a computer-readable medium 606, such as, but not limited to, a hard disk drive, a solid state drive, a Compact Disc (CD), a Digital Versatile Disk (DVD), a digital tape, memory, etc. In some implementations, the signal bearing medium 602 may encompass a recordable medium 608, such as, but not limited to, memory, read/write (R/W) CDs, R/W DVDs, etc. In some implementations, the signal bearing medium 602 may encompass a communications medium 610, such as, but not limited to, a digital and/or an analog communication medium (e.g., a fiber optic cable, a waveguide, a wired communications link, a wireless communication link, etc.). For example, the program product 600 may be conveyed to one or more modules of the processor 404 by an RF signal bearing medium, where the signal bearing medium 602 is conveyed by the wireless communications medium 610 (e.g., a wireless communications medium conforming with the IEEE 802.11 standard).

According to some embodiments, methods for the construction of a hash table for utilization in a recognition of a target object in an image may be described. The methods may include receiving a category information of the target object, expanding the category information into an object list, retrieving hash collections associated with the object list, and joining the hash collections into the hash table.

According to other embodiments, the target object may include an identity of an entity provided for the recognition, where the entity may be optionally associated with the image. The hash collections are retrieved from a hash data store configured to manage object hash tables that store object patterns. Expanding the category information includes determining conflicting objects based on the category information, where the conflicting objects are known to conflict with the target object, generating identifications for the conflicting objects, and adding the identifications to the object list to eliminate false positive matches to at least one of the hash collections. Expanding the category information also includes locating similar objects based on the category information from an object definition data source, and adding identification of the similar objects to the object list.

According to further embodiments, the methods may also include matching one or more identifications within the object list to object hash tables that are stored separately within a hash data store, and retrieving the hash collections from the object hash tables, where the hash collections are related to the one or more identifications. The hash collections may be processed into the hash table through a key and an associated value for each hash within the hash collections. The key is a tuple or a dictionary associated with the target object. The key is a metric of a hash from the hash collections related to the target object. The image is a two dimensional graphic or a three dimensional graphic.

According to other embodiments, the methods may also include receiving another category information and another image to generate object hash tables associated with another target object, and determining a library training material associated with the other category information and the other image. Object hash tables may be generated for the other target object based on the other category information, the other image, and the library training material, and the object hash tables may be stored in a hash data store.

According to some embodiments, a hash table server configured to construct a hash table for utilization in a recognition of a target object in an image may be described. The hash table server may include a memory configured to store instructions and a processor coupled to the memory. The processor may be configured to receive a category information of the target object that includes an identity of an entity provided for the recognition, where the entity is optionally associated with the image, expand the category information into an object list, retrieve hash collections associated with the object list from a hash data store configured to manage object hash tables that store object patterns, and join the hash collections into the hash table.

According to other embodiments, the processor may be further configured to determine conflicting objects based on the category information, where the conflicting objects are known to conflict with the target object, generate identifications for the conflicting objects, add the identifications to the object list to eliminate false positive matches to at least one of the hash collections, locate similar objects based on the category information from an object definition data source, and add identifications of the similar objects to the object list. The hash collections may be processed into the hash table through a key and an associated value for each hash within the hash collections, where the key is a tuple or a dictionary associated with the target object and the key is a metric of a hash from the hash collections related to the target object.

According to further embodiments, the processor may be further configured to receive another category information and another image to generate object hash tables associated with another target object, and determine a library training material associated with the other category information and the other image. Object hash tables may be generated for the other target object based on the other category information, the other image, and the library training material, and the object hash tables may be stored in the hash data store.

According to some embodiments, a system may be described. The system may include a client device configured to capture an image, and a hash table server configured to construct a hash table for utilization in a recognition of a target object in the captured image. The hash table server may include a memory configured to store instructions and a processor coupled to the memory. The processor may be configured to receive a category information of the target object that includes an identity of an entity provided for the recognition, where the entity is optionally associated with the image that is a two dimensional graphic or a three dimensional graphic, expand the category information into an object list, retrieve hash collections associated with the object list from a hash data store configured to manage object hash tables that store object patterns, and join the hash collections into a hash table.

According to other embodiments, the processor may be further configured to determine conflicting objects based on the category information, where the conflicting objects are known to conflict with the target object, generate identifications for the conflicting objects, add the identifications to the object list to eliminate false positive matches to at least one of the hash collections, locate similar objects based on the category information from an object definition data source, and add identifications of the similar objects into the object list. The hash collections may be processed into the hash table through a key and an associated value for each hash within the hash collections, where the key is a tuple or a dictionary associated with the target object and the key is a metric of a hash from the hash collections related to the target object.

According to further embodiments, the processor may be further configured to receive another category information and another image to generate object hash tables associated with another target object, determine a library training material associated with the other category information and the other image, generate object hash tables for the other target object through processing the other category information and the other image with library training material, and store the object hash tables in the hash data store.

According to some examples, a computer-readable non-transitory storage medium with instructions stored to construct a hash table for utilization in a recognition of a target object in the captured image may be described. The instructions may cause a method to be performed in response to execution, the method being similar to the methods described above.

There is little distinction left between hardware and software implementations of aspects of systems; the use of hardware or software is generally (but not all of the time, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof as understood by a person having ordinary skill in the art. In one example, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of the disclosure.

The present disclosure is not to be limited in terms of the particular embodiments described in the application, which are intended as illustrations of various aspects. Many modifications and variations may be made without departing from the spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited by the terms of the appended claims, along with the full scope of equivalents to which such claims are entitled. It is to be understood that the disclosure is not limited to particular methods, reagents, compounds compositions or biological systems, which may, of course, vary. It is also to be understood that the terminology used herein is for the purpose of describing particular embodiments, and is not intended to be limiting.

In addition, those skilled in the art will appreciate that the mechanisms of the subject matter described herein are capable of being distributed as a program product in a variety of forms and that an illustrative example of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and application programs, one or more interaction devices, such as a touch pad or screen, and/or control systems including feedback loops and control motors (for example, feedback for sensing position and/or velocity of gantry systems; control motors for moving and/or adjusting components and/or quantities).

A system may be implemented using any suitable commercially available components, such as those found in data computing/communication and/or network computing/communication systems. The herein described subject matter sometimes illustrates different components contained within, or connected with, other different components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected,” or “operably coupled,” to each other to achieve the desired functionality, and any two components capable of being so associated may also be viewed as being “operably couplable,” to each other to achieve the desired functionality. Specific examples of operably couplable include, but are not limited to, physically connectable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or the application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like include the number recited and refer to ranges which may be subsequently broken down into subranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to construct a hash table for utilization in a recognition of a target object in an image, the method comprising:
receiving a category information of the target object;
expanding the category information into an object list;
matching one or more identifications within the object list to object hash tables that store object patterns;
retrieving hash collections associated with the object list from the object hash tables; and
joining the hash collections into the hash table.

2. The method of claim 1, wherein the target object includes an identity of an entity provided for the recognition and, wherein the entity is optionally associated with the image.

3. The method of claim 1, wherein the the object hash tables are stored separately in a hash data store configured to manage the object hash tables.

4. The method of claim 1, wherein expanding the category information comprises:
determining conflicting objects based on the category information, wherein the conflicting objects are known to conflict with the target object;
generating identifications for the conflicting objects; and
adding the identifications to the object list to eliminate false positive matches to at least one of the hash collections.

5. The method of claim 1, wherein expanding the category information comprises:
locating similar objects based on the category information from an object definition data source; and
adding identification of the similar objects to the object list.

6. The method of claim 1,
wherein the hash collections are related to the one or more identifications.

7. The method of claim 1, further comprising:
processing the hash collections into the hash table through a key and an associated value for each hash within the hash collections.

8. The method of claim 7, wherein the key is a tuple or a dictionary associated with the target object.

9. The method of claim 7, wherein the key is a metric of a hash from the hash collections related to the target object.

10. The method of claim 1, wherein the image is a two dimensional graphic or a three dimensional graphic.

11. The method of claim 1, further comprising:
receiving another category information and another image to generate object hash tables associated with another target object; and
determining a library training material associated with the other category information and the other image.

12. The method of claim 11, further comprising:
generating object hash tables for the other target object based on the other category information, the other image, and the library training material; and
storing the object hash tables in a hash data store.

13. A hash table server configured to construct a hash table for utilization in a recognition of a target object in an image, the hash table server comprising:
a memory configured to store instructions;
a processor coupled to the memory, wherein the processor is configured to:
receive a category information of the target object that includes an identity of an entity provided for the recognition, wherein the entity is optionally associated with the image;
expand the category information into an object list;
matching one or more identifications within the object list to object hash tables that store object patterns;
retrieve hash collections associated with the object list from the object hash tables stored in a hash data store; and
join the hash collections into the hash table.

14. The hash table server of claim 13, wherein the processor is further configured to:
determine conflicting objects based on the category information, wherein the conflicting objects are known to conflict with the target object;
generate identifications for the conflicting objects;
add the identifications to the object list to eliminate false positive matches to at least one of the hash collections;
locate similar objects based on the category information from an object definition data source; and
add identifications of the similar objects to the object list.

15. The hash table server of claim 13, wherein the processor is further configured to:
process the hash collections into the hash table through a key and an associated value for each hash within the hash collections, wherein the key is a tuple or a dictionary associated with the target object and the key is a metric of a hash from the hash collections related to the target object.

16. The hash table server of claim 13, wherein the processor is further configured to:
receive another category information and another image to generate object hash tables associated with another target object; and
determine a library training material associated with the other category information and the other image.

17.-21. (canceled)

22. A computer-readable storage medium with instructions stored thereon to construct a hash table for utilization in a recognition of a target object in an image, the instructions, in response to execution by a processor, cause the processor to:
receive a category information of the target object that includes an identity of an entity provided for the recognition, wherein the entity is optionally associated with the image that is a two dimensional graphic or a three dimensional graphic;
expand the category information into an object list;
match one or more identifications within the object list to object hash tables that store object patterns;
retrieve hash collections associated with the object list from the object hash tables stored in a hash data store; and
join the hash collections into a hash table.

23. The computer-readable storage medium of claim 22, wherein the instructions further cause the processor to:
determine conflicting objects based on the category information, wherein the conflicting objects are known to conflict with the target object;
generate identifications for the conflicting objects;
add the identifications to the object list to eliminate false positive matches to at least one of the hash collections;
locate similar objects based on the category information from an object definition data source; and
add identifications of the similar objects into the object list.

24. The computer-readable storage medium of claim 22, wherein the instructions further cause the processor to:
process the hash collections into the hash table through a key and an associated value for each hash within the hash collections, wherein the key is a tuple or a dictionary associated with the target object and the key is a metric of a hash from the hash collections related to the target object.

25. The computer-readable storage medium of claim 22, wherein the instructions further cause the processor to:
receive another category information and another image to generate object hash tables associated with another target object;
determine a library training material associated with the other category information and the other image;
generate object hash tables for the other target object through processing the other category information and the other image with library training material; and
store the object hash tables in the hash data store.
